(19) United States
(12) Patent Application Publication
(10) Pub. No.: US 2004/0243616 A1
(43) Pub. Date: Dec. 2, 2004

(54) Sorting and filtering a treetable using the indices of the rows

(75) Inventors: Linda V. Benhase, Tucson, AZ (US); Mary C. Burton, Tucson, AZ (US); Shekhar G. Kale, Sunnyvale, CA (US); Amy N. Morris, San Jose, CA (US); Maria S. Rajakannimariyan, San Jose, CA (US)

Correspondence Address: SCULLY SCOTT MURPHY & PRESSER, PC, 400 GARDEN CITY PLAZA, GARDEN CITY, NY, 11530

(73) Assignee: International Business Machines Corporation, Armonk, NY (US)

(21) Appl. No.: 10/449,785

(22) Filed: May 30, 2003

(51) Int. Cl. G06F 7/00

(52) U.S. Cl. 707/102

(57) ABSTRACT

A user interface for a computer system that provides a display of a tree and corresponding table, e.g., a “treetable” display. The tree is updated based on filter and sort operations applied to the table. Tree nodes may represent storage resources of a computer system such as a storage server, logical storage resources, volumes, disks, and the like. Filtering may be based on storage resource identifier, storage resource size, copy type, copy status, copy progress, and characteristics of a copy relationship, such as an identifier of another storage resource that is a source or target resource for copying. The table is updated to display only the information associated with the child nodes that meet the filtering conditions, and their parent nodes, while omitting the information for remaining nodes. Rows of the table displaying information for multiple copy relationships associated with a node remain grouped after sorting or filtering.

### BACKGROUND OF THE INVENTION

1. Field of Invention

The invention relates generally to a user interface for a computer system that provides a display of a tree and corresponding table, e.g., a “treetable” display, where the tree is updated based on filter and sort operations applied to the table.

2. Description of Related Art

Computer-generated user interfaces provide the user with important information regarding files or other resources associated with a computer system. In some interfaces, such as Windows Explorer(r), a tree-based file directory can be displayed adjacent to a list or table of files and associated information on the computer monitor. For example, the tree may indicate various directories and subdirectories arranged in an expandable and collapsible format. When the user clicks on a subdirectory using a mouse or other pointing device, the list or table of files is updated to display the files for the selected subdirectory. Information such as file name, file type, date modified and file size may be provided. Moreover, the user may perform a sort operation, e.g., to cause the files to be displayed in a sorted manner. However, there remains a need for a user interface that provides an updated tree in accordance with filter and sort operations applied to a table. There is also a need for a user interface that provides sort operations for a table while maintaining groupings of information associated with child nodes of the tree.

### BRIEF SUMMARY OF THE INVENTION

To overcome these and other deficiencies in the prior art, the present invention describes a user interface for a computer system that provides a display of a tree and corresponding table, where the tree is updated based on filter and sort operations applied to the table. Additionally, sort operations are provided for the table while maintaining groupings of information associated with child nodes of the tree.

In one aspect of the invention, a computer-generated user interface for displaying information is provided. The interface includes a first display region having a tree with hierarchically-arranged nodes including a parent node and child nodes thereof, and a second display region having a table for displaying information associated with the child nodes. In accordance with a filter command, the table is updated to display information associated with a subset of the child nodes that meets conditions of the filter command while omitting information associated with remaining ones of the child nodes that do not meet the conditions of the filter command. Also, the tree is updated to display the subset of child nodes and the parent node while omitting the remaining ones of the child nodes. Thus, the tree is updated concurrently with the table so they remain consistent.

In a further aspect of the invention, an interface for displaying information includes a first display region having a tree with hierarchically-arranged nodes representing storage resources in a computer system, including a parent node and child nodes thereof, and a second display region having a table for displaying information associated with the child nodes, including information regarding multiple copy relationships associated with the child nodes which is grouped in corresponding multiple rows of the table. In accordance with a sort command applied to the table, the multiple rows for the multiple copy relationships associated with the child nodes are sorted while remaining grouped in the table. Thus, sorting is applied independently for each child node.

In a further aspect of the invention, an interface for displaying information includes a first display region having a tree with hierarchically-arranged nodes including a parent node and child nodes thereof, wherein the child nodes are in a first node order. A second display region has a table with rows in a first row order for displaying information associated with the child nodes. In accordance with a sort command applied to the table, the table is updated so that the rows are in a second row order, and the tree is updated so that the child nodes are in a second node order in accordance with the second row order.

In a further aspect of the invention, an interface for displaying information includes a first display region having a tree with hierarchically-arranged nodes including a parent node and child nodes, and a second display region having a table for displaying information associated with the child nodes. In accordance with a filter command, the table is updated to display information associated with a subset of the child nodes which meets conditions of the filter command while omitting information associated with remaining ones of the child nodes which do not meet the conditions of the filter command, and the tree is updated to display the subset of child nodes and the parent node while omitting the remaining ones of the child nodes. Additionally, a flag is provided for each child node indicating whether or not it meets the conditions of the filter command. The tree is updated by identifying the subset of the child nodes that meets the conditions of the filter command according to the flag of each child node. Also, a flag is provided for the parent node indicating that it meets the conditions of the filter command when at least one of child nodes meets the conditions of the filter command.

Related computer program products are also provided.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates an overview of storage servers, hosts, and a user interface in a computer system;

FIG. 2 illustrates an overview of a logical structure of a storage server;

FIG. 3 illustrates an example tree with hierarchically-arranged nodes;

FIG. 4 illustrates a user interface display with a tree and a table for displaying information associated with storage resources in a computer system;

FIG. 5 illustrates a modified version of the display of FIG. 4 where a descending sort on “resource identifier” of the selected resource is performed;

FIG. 6 illustrates a modified version of the display of FIG. 4 where a sort on “copy type” is performed;

FIG. 7 illustrates a modified version of the display of FIG. 4 where a sort on “size” is performed; and

FIG. 8 illustrates a modified version of the display of FIG. 4 where a filter on “sector size of 5 to 10 sectors” is performed;

FIG. 9 illustrates an interface for entering filtering commands;

FIG. 10 illustrates a method for filtering and sorting a table; and

FIG. 11 illustrates a method for sorting a table.

### DETAILED DESCRIPTION OF THE INVENTION

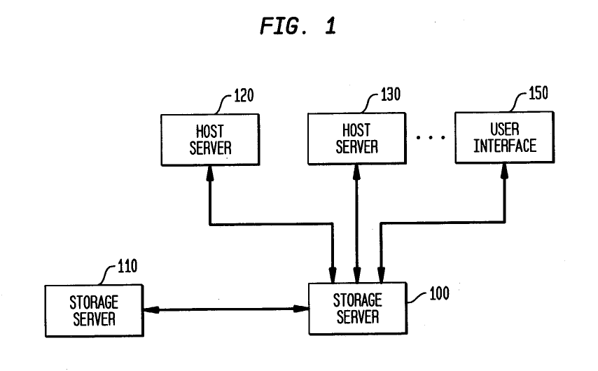

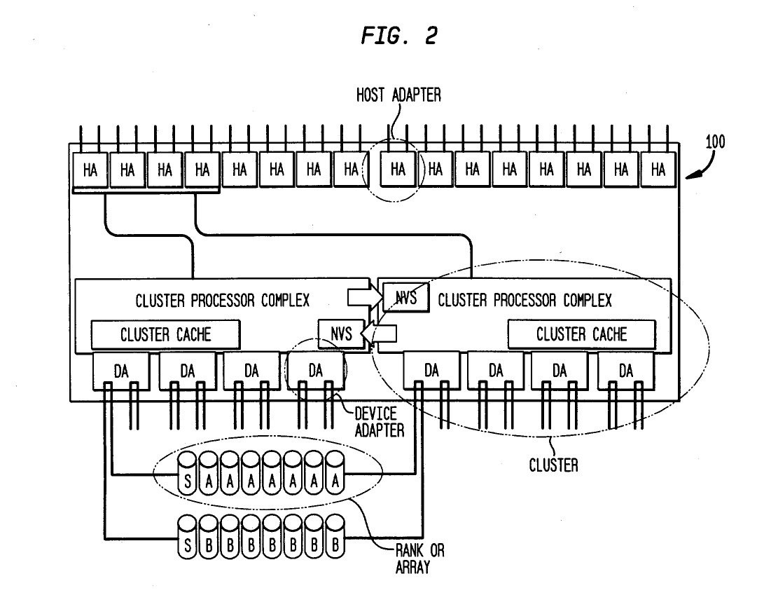

A computer-generated user interface according to the invention may be used in essentially any application where information can be represented by hierarchically arranged nodes in a tree, and a table displays information associated with the nodes. In an example embodiment, the interface is described for use with storage resources of a computer system. FIGS. 1 and 2 describe an example computer system.

FIG. 1 illustrates an overview of storage servers, hosts, and a user interface in a computer system. Storage servers 100 and 110, which may be IBM Enterprise Storage Servers (ESSs), for instance, host servers 120 and 130 or other hosts, and a user interface 150 are illustrated in a simplified example. The storage servers 100 and 110 typically can connect to a variety of host servers, which may be servers that store data for different networks. For example, a large corporation or other enterprise may have a network of servers that each store data for a number of workstations used by individual employees. Periodically, the data on the host servers 120, 130 is backed up to the high-capacity storage server 100 to avoid data loss if the host servers 120, 130 malfunction. The storage server 100 can also provide data sharing between host servers since it is accessible to each host server. The storage server 100 itself may have redundant storage resources to provide an additional safeguard against data loss. However, as a further measure, the data of the storage server 100 may be mirrored to another storage server, such as storage server 110, which is typically at a remote site. Note that multiple storage servers may also be present at one site to provide a sufficient backup capability to a group of hosts. A storage server of a particular type, such as one that uses disk storage, may connect to one or more other peer disk storage servers as well as to other storage devices, such as those using magnetic tape. Communication between the devices may be achieved using any desired communication protocol and medium.

The user interface 150 may include a workstation with video screen. The computing resources of the workstation run software, e.g., by executing computer code devices such as computer code in a known manner, to access information in the storage server 100 to generate a display that allows the user to set up source-target pairs of storage resources for copying data, and provides information regarding the status of copying activities in the storage server 100.

FIG. 2 illustrates an overview of a logical structure of the storage server 100. The example shown relates to the IBM Enterprise Storage Server (ESS), which includes special features such as redundant storage resources that may not be used in other storage devices. However, the overview is an example only to show one way in which a storage server may connect to other devices and arrange the storage of data internally. The user interface of the present invention does not require the specific configuration shown, and is suitable for use with other storage devices, as will be apparent to those skilled in the art.

The storage server 100 includes two clusters for redundancy. Each cluster includes a cluster processor complex, a cluster cache, and device adapters to connect disk storage resources to the cluster processor complexes. The cluster processor complexes each work independently. Each may contain symmetric multi processors with (volatile) cache, non-volatile storage/cache (NVS), and device adapters (DA). The device adapters, which are installed in pairs, one in each cluster, are used to connect disks to the cluster processor complexes. Disk arrays or ranks are attached to the two DAs. The ranks can be configured as RAID 5 (redundant array of independent disks) or non-RAID arrays. In the ranks, “S” indicates a spare disk and “A” and “B” identify the rank.

Host adapters (HAs) are external interfaces which may support two ports, either small computer systems interface (SCSI) or IBM's enterprise systems connection (ESCON), which is an Enterprise Systems Architecture/390 and zSeries computer peripheral interface. This I/O interface uses ESA/390 logical protocols over a serial interface that configures attached units to a communication fabric. For example, the remote storage server 110, host servers 120, 130 and the user interface 150 may communicate with the storage server 100 via the HAs. Fibre channel or fibre-channel connection (FICON) has support for one channel per HA. Each HA connects to both cluster processor complexes so that either cluster can handle I/Os from any host adapter. A system adapter identification number (SAID) is a unique identification number automatically assigned to each HA.

The user interface 150 communicates with the storage server 100 to obtain information regarding the storage resources and the status of copy operations. Additionally, the user interface 150 communicates instructions for setting up source-target pairs and initiating copying operations. The user interface 150 may also communicate with the host servers 120, 130 and other hosts, as well as the storage server 110, via the storage server 100 via or other paths. Software may run on the user interface 150 alone, or on both the interface 150 and the storage server 100, e.g., as a distributed application, to achieve the desired flow of information using known computing techniques. For example, processing resources in the storage server 100, such as in the cluster processor complexes or other processor not specifically shown, may maintain information regarding a hierarchy of storage resources. At the first, highest level of the hierarchy is the device level, which may include the storage servers 100 and 110, and the host servers 120 and 130. The second level represents storage resources within a specific device. For example, the storage servers and hosts may have logical subsystems (LSSs), which in turn are comprised of volumes, in the third level of the hierarchy. The LSS is a topological construct that includes a group of logical devices such as logical volumes, which may be units of recording medium associated with a logical disk drive. For example, a logical volume in a RAID array may be spread over the disks in the array. The units may include sectors of one or more disks.

The processing resources in the storage server 100 may continuously monitor the activities of the various storage resources, including whether a resource has been designated as a source resource from which data is copied, or a target resource to which data is copied, which resources are paired in a copy relationship, e.g., a copy event, whether data is currently being read from, or written to, a resource, what type of copying is occurring, e.g., peer-to-peer or point-in-time, which sectors of a disk resource are involved in copying, what percent of the copying has been completed, and whether copying has been temporarily suspended. Information regarding these activities may be tracked using appropriate data constructs in a database that is dynamically updated as the information changes. Information that does not usually change, such as the size and type of the storage resource, can also be maintained.

Moreover, when storage resources external to a single storage device are involved in a copying operation with the subject storage device 100, such as another storage device 110, or host servers 120 and 130, the processing resources in the storage server 100 may communicate with these external devices to obtain analogous information regarding their storage resources.

The various types of copying operations that may occur may be classified generally as point-in-time copying and continual copying. An example of point-in-time copying is flash copying, which provides an instant copy of a volume, e.g., within the storage device 100. This may be used to create test data, temporary checkpoint copies, or for asynchronous backup, or to perform data mining and data warehousing on the copied data. Concurrent copying, another form of point in time copy, provides a copy of a volume or data set within a few seconds. It enables a program to make a backup of a data set while the logical volume remains available for subsequent processing. The data in the backup copy is frozen at the point-in-time that the server responds to the request. Concurrent copying is generally used with mainframe host computers.

An example of continual copying is peer-to-peer remote copying (PPRC), e.g., between the storage servers 100 and 110, or within a storage server. PPRC provides synchronous mirroring, and is typically used as a disaster recovery solution. It maintains a consistent copy of a logical volume on the same storage server or on another storage server. All modifications that any attached host performs on the primary logical volume are also performed on the secondary logical volume. A related type of copying, PPRC extended distance, maintains a fuzzy copy of a logical volume on the same ESS or on another ESS. In other words, all modifications that any attached host performs on the primary logical volume are also performed on the secondary logical volume at a later point-in-time. The original order of update is not strictly maintained. When the copying is performed within a storage server, which is less common than storage server-to-storage server copying, the copying may be thought of as non-remote peer-to-peer copying. However, for simplicity, the terms “PPRC” and “peer-to-peer” as used herein should be considered to encompass both remote and non-remote peer-to-peer copying.

Extended remote copying (XRC), e.g., between the storage server 100 and host 120 and 130, provides asynchronous mirroring. It assists a control program to maintain a consistent copy of a logical volume on another storage facility. All modifications of the primary logical volume by any attached host are presented in order to a single host. The host then makes these modifications on the secondary logical volume. XRC is generally used with mainframe host computers.

A suitable user interface may be provided for setting up source-target pairs in copy relationships.

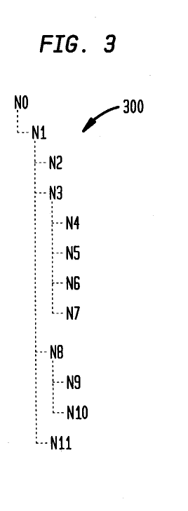

FIG. 3 illustrates an example tree with hierarchically-arranged nodes. The tree 300 is shown with a root node N0 at the top of the hierarchy, next level node N1, and next level nodes N2, N3, N8 and N11. Node N2 has no children node, and is therefore a leaf node, e.g., a lowest level node in the hierarchy. Node N3 is a parent node to nodes N4, N5, N6 and N7, which are leaf nodes. Node N8 is a parent node to nodes N9 and N10, which are leaf nodes. Node N11 has no children node, and is therefore also a leaf node. In a user interface, the node indicia N0, N1, and so forth may be replaced by indicia based on the particular application. For example, in a user interface for storage resources of a computer system, the node indicia may represent various storage resources, such as a storage server, logical storage resources, volumes, disks, and the like, as illustrated below.

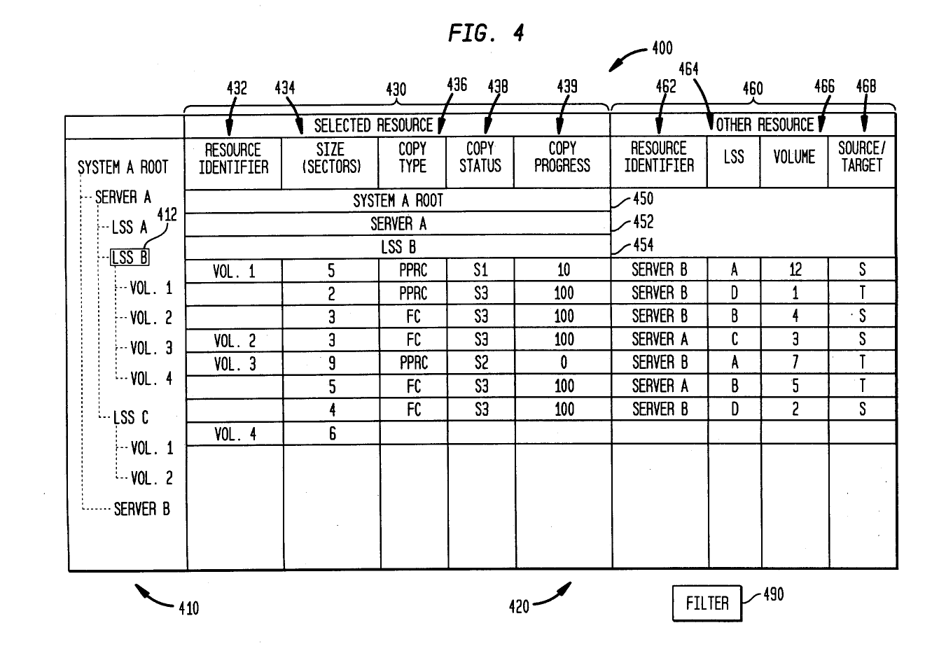

FIG. 4 illustrates a user interface display with a tree and a table for displaying information associated with storage resources in a computer system. The interface display 400 includes a first display region 410 including a tree, and a second display region 420 including a table with rows that provide information associated with nodes of the tree. In the present example, the nodes of the tree have indicia that represent various storage resources. For example, referring to the corresponding tree 300 of FIG. 3, N0 represents a root node of a storage system “A”. This may be the only storage system associated with the user interface 400, or there may be other storage systems as well. N1 represents a server “A”, which is a particular storage server in the system “A”. Other servers in system “A” include server “B”, referenced in column 462. N2 represents a logical storage resource such as a logical subsystem (LSS) “A”. N3 represents an additional LSS, namely LSS “B”. N4 through N7 represent volumes 1 through 4, respectively, of LSS B. N8 represents an additional LSS, namely LSS “C”. N9 and N10 represent volumes 1 and 2, respectively, of LSS C. N11 represents an additional storage server “B” in system “A”. The tree may be displayed with portion collapsed or expanded form as is known in the art. Additional portions of the tree that do not fit in the display region 410 can be viewed by scrolling down using a slide bar, up/down arrow indicia or other appropriate devices.

In second display region 420, a number of columns and rows provided information associated with particular storage resources represented by the tree. In one example, the columns 430 provide information regarding a selected resource of the tree. The user selects a storage resource of the tree by selecting the corresponding node, e.g., by clicking on it with a mouse or other pointing device. In the present example, the storage resource represented by node “LSS B” 412 is selected. A column 432 provides a resource identifier of child storage resources, or component resource, associated with the selected storage resource, and column 434 provides a size of the child storage resources, e.g., in sectors. When a copy relationship has been set up for a child storage resource, column 436 indicates a copy type, column 438 indicates a copy status, and column 439 indicates a copy progress. The copy type can be PPRC or FC, for example. The copy status may be indicated by an icon or other indicia such as S1 for copy in progress, S2 for copy pending, and S3 for copy complete. The copy progress can be expressed in percent, for instance. Note that the copy relationships may be represented by nodes in the tree as well. For example, the three copy relationships for Vol. 1 can be represented by three child nodes of the node for Vol. 1.

Columns 460 provide information on another storage resource of a copy relationship. In particular, column 462 indicates a resource identifier, column 464 indicates an LSS, and column 466 indicates a volume. The resource identifier identifies another storage server, e.g., server “B”. This resource could alternatively be a host server, for instance. Column 468 indicates whether the resource is a source (S) or target (T). The complement of this column may be associated with the columns 430 of the selected resource as well. That is, if the other resource is a source, the selected resource is a target, and, if the other resource is a target, the selected resource is a source.

The rows of the table provide information for different nodes in the tree. Each row is associated with one node under the selected node. For example, since “LSS B” 412 is the selected node in the present example, rows of the table will provide information for the associated child nodes representing Vol. 1 through 4 as the selected resources under LSS B. Moreover, when a node has multiple copy relationships, a different row may be allocated to provide information regarding each different copy relationship. Additional rows are used to display information identifying the parent nodes of the selected resources. For example, row 450 displays the top level node indicia “system A root”, row 452 displays the next level node indicia “server A”, and row 454 displays the next level (and selected) node indicia “LSS B”. This assists the user in understanding a context of the displayed information in the table. This is optional, however, as the context is also provided in the tree and highlighting of location in the tree node.

On subsequent rows, information is displayed for Vol. 1 through 4 in turn. The table may be set up to automatically sort on the resource identifier of the selected resource in column 432 to achieve this arrangement. Vol. 1 and 3 each has three copy relationships, while Vol. 2 has one copy relationship, and Vol. 4 currently has no copy relationships. A copy relationship generally indicates a copy action that has been set up to run, is in progress, or has completed. A storage resource may be involved in multiple copy relationships, e.g., when it is writing to different target resources, reading from different source resources, or both writing and reading, for instance.

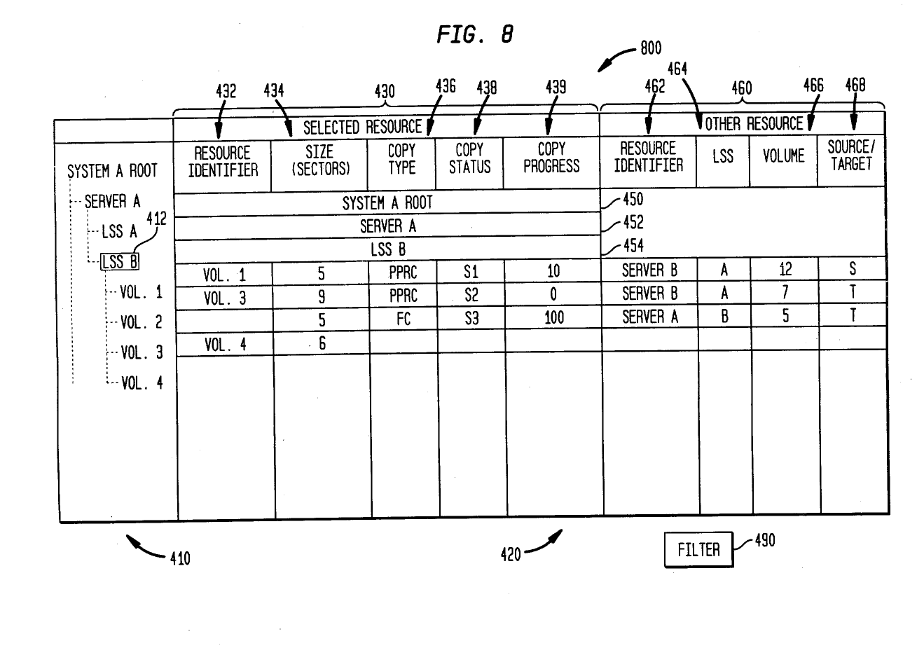

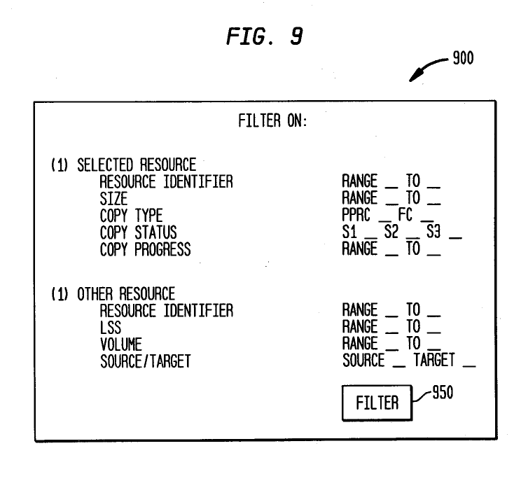

In accordance with the invention, the user may customize the display of the interface 400 by invoking sorting and/or filtering commands. Sorting commands may be applied to the table, for instance, by clicking on the header or title of each column using a mouse or other pointing device or by invoking a separate user interface. In one possible approach, the user can toggle between ascending and descending sorts. A “filter” button 490 can be selected by the user to invoke filtering, as discussed specifically in connection with FIGS. 8 and 9. Instead of having the filter button 490, filtering could be based on a column heading and thus associated with these headings. For example, choosing a show filter row function in the table causes a row of filter buttons to be displayed immediately below the column headings.

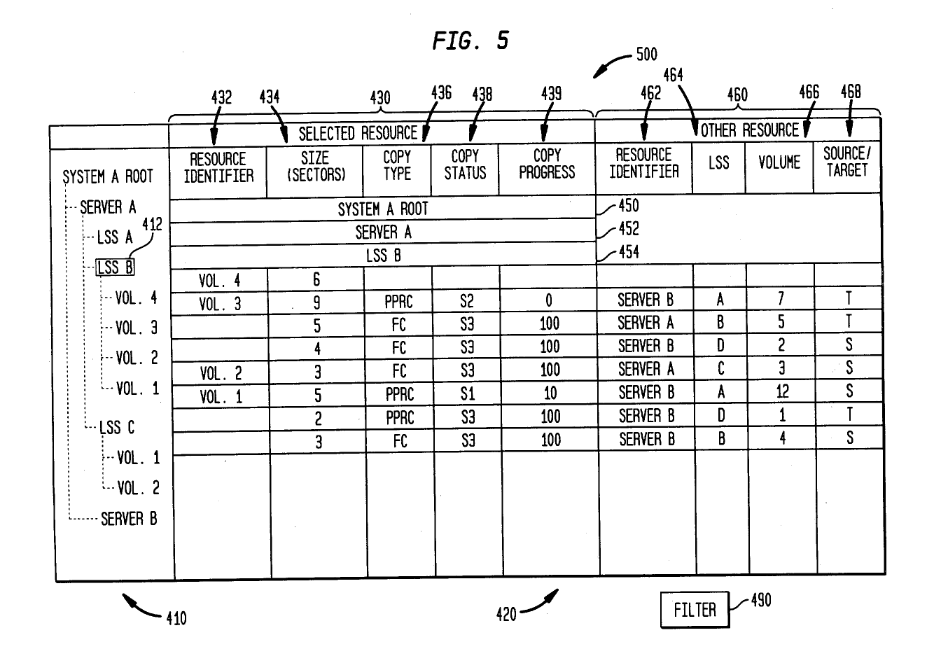

For example, FIG. 5 illustrates a modified version of the display of FIG. 4 where a descending sort on “resource identifier” of the selected resource is performed. As seen in column 432 of the display 500, the rows display information for volumes 4, 3, 2 and 1. Additionally, the multiple rows providing information for the corresponding multiple copy relationships of a given resource, such as for Volumes 1 and 3, remain grouped, e.g., in successive rows, even after sorting. As a general rule, the rows that display information regarding multiple copy relationships should remain grouped with the associated selected storage resource after a sort or filter operation. The node order in the tree in the first display region 410 may also be updated accordingly. Thus, the table is updated so that the row order is changed from a first row order to a second row order, and the tree is updated so that the child nodes are changed from a first node order to a second node order in accordance with the second row order. This assists the user in understanding with which resource a copy relationship is associated.

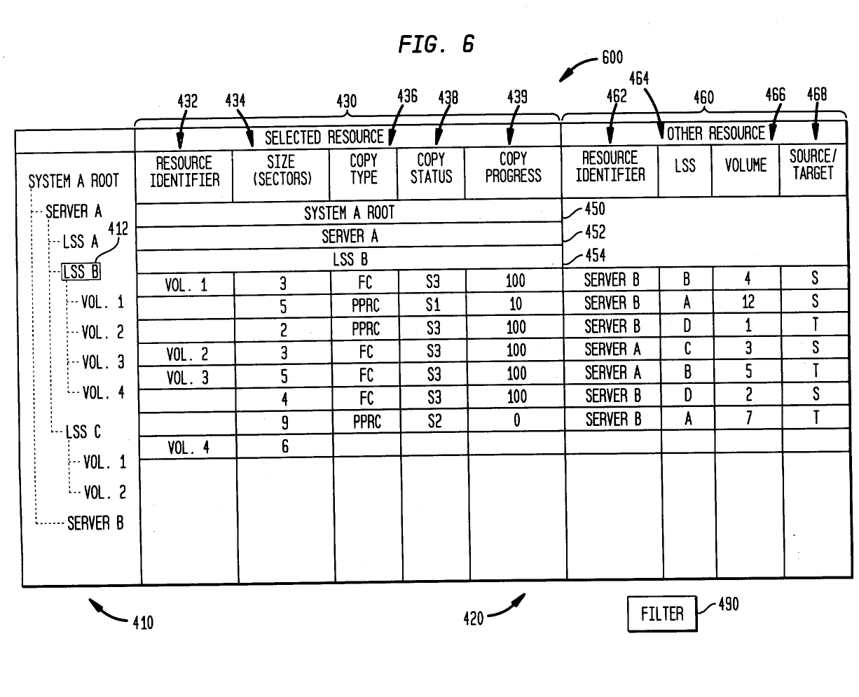

FIG. 6 illustrates a modified version of the display of FIG. 4 where a sort on “copy type” is performed. As seen in column 436 of the display 600, the rows for Volumes 1 and 3 display the FC copy relationship information before the PPRC copy relationship information since “F” is before “P” in the alphabet. No sorting is applied to the row for volumes 2 and 4 since they do not have multiple copy relationships. Again, the information for multiple copy relationships of a storage resource is maintained grouped in successive rows.

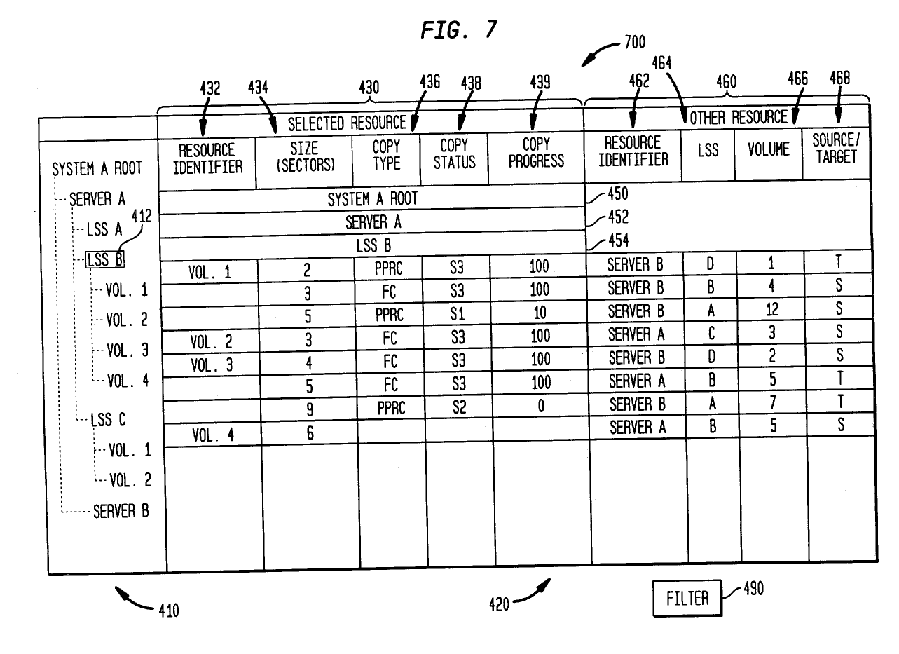

FIG. 7 illustrates a modified version of the display of FIG. 4 where a sort on “size” is performed. As seen in column 434 of the display 700, the rows for Vol. 1 display the copy relationship for the 2 sectors that are a source resource, then the 3 sectors that are a target resource, and then the 5 sectors that are a target resource. The rows for Vol. 3 display the copy relationship for the 4 sectors that are a target resource, then the 5 sectors that are a source resource, and then the 9 sectors that are a source resource.

FIG. 8 illustrates a modified version of the display of FIG. 4 where a filter on “sector size of 5 to 10 sectors” is performed. The user may invoke a filter command to obtain the updated interface 800 where the only rows of the table that are displayed are those associated with a storage resource having a copy relationship in which 5 to 10 sectors are copied, or a storage resource having 5 to 10 sectors. Note that sector size generally is static. Filtering may be based on static or dynamic information. By comparison to the interface 400, it can be seen that the rows for Vol. 1 having 2 and 3 sectors are omitted, the row for Vol. 2 having 3 sectors is omitted, and the row for Vol. 3 having 4 sectors is omitted. Thus, information for a subset of the nodes that meet the filter conditions are displayed. It may be desirable for the user to view a filtered interface for various reasons, such as to focus in on specific conditions of interest. As another example, the user may filter on the copy status code in column 48 to view the storage resources with a certain copy status. A filter command can be invoked in various ways, as discussed below.

FIG. 9 illustrates an interface for entering filtering commands. The interface 900 may be invoked by clicking on an appropriate device, such as the “filter” button 490 (FIGS. 4-8). In response, an interface 900 may appear as a window that is overlaid on the interfaces 400 or by itself on a new screen. The filtering interface 900 provides the user with various options associated with the selected resource of the tree, and/or the other resource in a copy relationship. The user may enter alphanumeric values to filter on a range of values, or use check boxes to select specific filtering criteria. For example, for the selected resource, the user may filter on a resource identifier, size, copy type, copy status, and copy progress. For the other resource, the user may filter on the resource identifier, LSS, volume, and source/target status. Note that multiple filtering conditions may be set as well. Once the user enters the desired filtering conditions, a “filter” button 950 may be selected to update the table of the user interface.

Furthermore, it is possible for filtering and sorting commands to be saved and invoked for future use. It is also possible to update the user interface based on sort and filter operations together, as well as to perform successive sort and/or filter operations to “drill down” to desired information.

Advantageously, the user interface displays the hierarchically organized tree together with associated information in a table so that all information is available at a glance, and there is no need for additional windows to show additional information. Appropriate software techniques for generating the user interface and the functionality described herein should be apparent to those skilled in the art. Details of an example implementation follow.

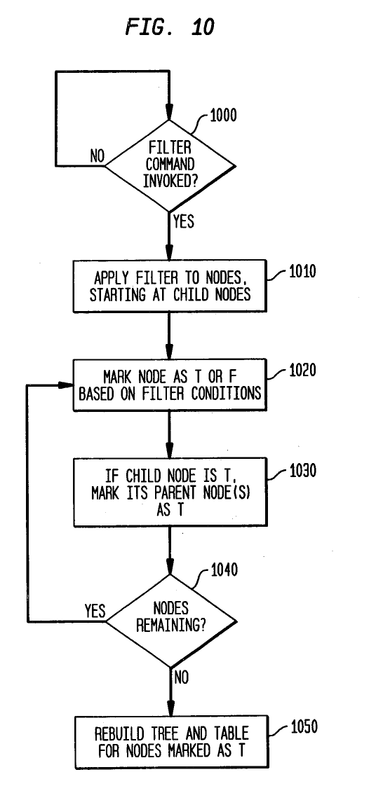

FIG. 10 illustrates a method for filtering and sorting a table. Columns can have predefined (canned) filters, or user-specified filters. Canned filters are filters with limited choices. For example, the copy status column 438 (FIG. 4) can filter using a list of tasks or statuses. The user may select one or more tasks to view. The result set of the filter will display the volumes that are involved in the selected tasks. A user specified filter is an open filter. The user can specify the criteria to be applied to the table through a user interface (UI) dialog box, such as in FIG. 9, or other means.

The node indicia of the tree can be in any column of the table. In the example of the interface 400, the node indicia, e.g., Vol. 1, Vol. 2, Vol. 3 and Vol. 4. are displayed in the first column of the table, in column 432. A column that displays the node indicia is said to have tree control since the information in that column depends directly on the displayed tree nodes. The information displayed in the other columns of the table are dependent on the column with tree control. For example, in the interface 400, the remaining columns 434, 436, 438, 439, 462, 464, 466 and 468 depend on column 432. At least one row of the table is used to display information for the child nodes of the selected node. Multiple rows are used to display information for multiple copy relationships of the storage resource represented by a node.

Data constructs such as flags may be associated with the selected node and its child nodes to indicate if they are part of filter and/or sort results. The following restrictions may be imposed while displaying sort and filter results:

1. If the children of a node are a part of sort/filter results, the parent node will be displayed to maintain the relationship of parent-child nodes.

2. The sort/filter results will be displayed within the context of the parent node.

3. If the sort/filter operation is applied to a column that depends on a column with tree control, the sort/filter operation is applied based on the information displayed by the column containing the tree control. The tree control column controls the appearance of rest of the table as to how the other columns and rows will be filtered and sorted.

An example implementation is illustrated in FIG. 10. At block 1000, it is determined whether a filter command has been invoked. If so, at block 1010, the filter is applied to the nodes starting at the child nodes. In particular, a filter condition may be set for the information displayed in each column. A treetable control gets all the filter conditions from the table columns. Every column has a filter object. If there is no filter condition set based on the information displayed by a column, the column's filter will be null.

For example, the filtering condition may be to display information for nodes with a sector size of 5 to 10 sectors, as discussed in connection with FIG. 8. This condition is obtained from the corresponding column by the treetable control. There is no filtering based on the information displayed by the remaining columns, so their filters will be null. The one or more filters are applied to all nodes for the selected node and its child nodes, starting with the child nodes. At block 1020, the nodes are marked as true if the associated information meets the filter condition, or false if it does not. A binary flag may be used for this purpose in an appropriate data construct, e.g., with F=0 and T=1. The filtering conditions may be applied in the order of depth-first, so that the children will go through the filtering mechanism before the parent nodes. At block 1030, if any one of the parent's children nodes are marked as true, the filter will not be applied to the one or more parent nodes. Instead, the parent nodes will be marked as true since it is desirable to display the parent when its children are displayed even if the parent does not necessarily match with the filter conditions. Using the example of filtering based on a sector size of 5 to 10 sectors, it can be seen from the interface 400 that nodes for Vol. 1, Vol. 3 and Vol. 4 will be marked as true (T), and the node for Vol. 2 will be marked as false (F). Additionally, the higher level parent nodes LSS B, Server A and System A root will be marked as T. The nodes that are not selected are marked as F. These include nodes LSS A, LSS C and its children Vol. 1 and Vol. 2, and Server B. At block 1040, any remaining nodes are marked.

At block 1050, the tree and table displays are rebuilt for the nodes marked T, e.g., to arrive at the interface 800 of FIG. 8. Various software techniques may be used to achieve this. For example, a node-structure-changed event using Java may be fired to the tree control to rebuild the tree from the root. This event will draw all the top nodes and generate a value-changed event to the table control. This will build up indices to display all the required tree nodes. The tree and table will be built up with filtered and/or sorted nodes. During the tree construction, any sort command will be applied to the parent's filtered children. Every node's state will be remembered for future use. For example, to display the results of sort and filter operations uniformly, the treetable control may generate indices of the rows of the table, e.g., row 1, row 2 and so forth and remember the sort and filter results at each node of the tree. Each node may be assigned an index, such as N1, N2, N3 and so on (FIG. 3). The true or false flag is then associated with the node index. For sorting, a sequence number or other index can be associated with each node index. When the table is updated, the information for a specific node can be written in a specific row by associating a node index with a row index. For instance, an instruction such as “write the information for node N4 into row 3” can be used. When a node has multiple copy relationships, the node index is associated with indices of multiple rows. For instance, an instruction such as “write the information for node N4, copy relationship 1, into row 3”; “write the information for node N4, copy relationship 2, into row 4”; and “write the information for node N4, copy relationship 3, into row 5” can be used.

After reconstruction of the tree, the nodes will be traversed in the order of breadth-first. If the node has an expanded state, then an expand event will be sent the tree for the node. Expansion and collapsing of trees is known in the art. Typically a “+” or “−” icon in the tree display can be clicked on to expand or collapse a branch or node of a tree. Note that computations are reduced by applying the sort after the filter. Advantageously, the tree and table behave as one control so that a continuous view is available to the user. Moreover, sort and filter capabilities offer more flexibility to the user for viewing the data.

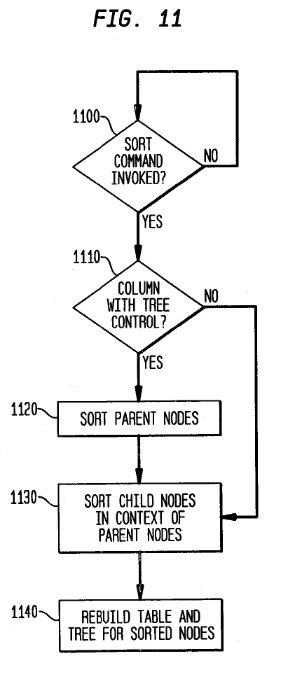

FIG. 11 illustrates a method for sorting a table. When a sort command is invoked at block 1100, it is determined whether the sorting is for a column with tree control, that is, a column that displays node indicia. If so, the parent nodes are sorted at block 1120. A sort command may apply to columns that contain tree control, and columns that depend on a column containing the tree control. Columns with tree control can be sorted in ascending or descending order. These are not dependent on other columns for displaying the data. The sorting will apply to the top level nodes of the tree. The sort will apply to the children nodes in the context of the parent node. Columns without tree control depend on the column containing the tree control for displaying information. If the tree nodes in the tree column are expanded or collapsed, the columns change. These columns contain a row for each child node of the tree in the tree column. The sort criteria will not apply to all the rows of the column. The sort will apply to the children rows within the context of the parent row (block 1130). For example, when the copy type column 436 is sorted, the table and tree will be rebuilt for the sorted nodes (block 1140) to display the sorted rows within the context of the volumes. If a volume participates in PPRC, FC, etc., then the copy type column will display FC(row1), PPRC(row2), and so on for that volume. Corresponding data will be displayed in the subsequent columns.

As an example, a sort is performed on the resource identifier in column 432 of the interface 400 of FIG. 4. The updated interface 500 of FIG. 5 shows the result. In this case, only one parent node was selected, namely LSS B 412. Thus, sorting at the parent node level is a degenerate case. Sorting at the child node level resulted in the nodes Vol. 1 through 4 being reordered to Vol. 4 through 1.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. A computer-generated user interface for displaying information, comprising:
a first display region having a tree with hierarchically-arranged nodes including at least one parent node and a plurality of child nodes thereof; and
a second display region having a table for displaying information associated with the child nodes;
wherein, in accordance with a filter command, the table is updated to display information associated with a subset of the child nodes which meets conditions of the filter command while omitting information associated with remaining ones of the child nodes which do not meet the conditions of the filter command, and the tree is updated to display the subset of child nodes and the at least one parent node while omitting the remaining ones of the child nodes.

2. The computer-generated user interface of claim 1, wherein:
the parent node and the plurality of child nodes represent storage resources in a computer system.

3. The computer-generated user interface of claim 1, wherein:
the parent node represents a logical storage resource in a computer system, and the child nodes represent volumes thereof.

4. The computer-generated user interface of claim 1, wherein:
the plurality of child nodes represent storage resources in a computer system, and the table provides information regarding at least one copy relationship of at least one of the storage resources.

5. The computer-generated user interface of claim 4, wherein:
the storage resources comprise volumes.

6. The computer-generated user interface of claim 4, wherein:
the filter command filters on at least one of storage resource identifier and storage resource size.

7. The computer-generated user interface of claim 4, wherein:
the filter command filters on characteristics of the at least one copy relationship, including at least one of: an identifier of another storage resource involved in at least one copy relationship, a source or target status thereof, copy type, copy status and copy progress.

8. The computer-generated user interface of claim 1, wherein:
the table displays the information associated with the child nodes in respective rows thereof; and
the table is updated by omitting rows which provide the information associated with the remaining ones of the child nodes.

9. The computer-generated user interface of claim 1, wherein:
the table displays an identifier of the at least one parent node in a row of the table above rows which display the information associated with the child nodes.

10. The computer-generated user interface of claim 1, wherein:
the first display region is displayed concurrently with the second display region.

11. The computer-generated user interface of claim 1, wherein:
indices are assigned to at least one parent node and the plurality of child nodes, and to rows of the table which display the information associated with the child nodes; and
the table is updated by associating indices of the subset of the child nodes which meets the conditions of the filter command with the indices of the rows.

12. The computer-generated user interface of claim 1, wherein:
a flag is provided for each of the plurality of child nodes indicating whether or not they meet the conditions of the filter command; and
the tree is updated by identifying the subset of the child nodes which meets the conditions of the filter command according to the flag of each of the plurality of child nodes.

13. The computer-generated user interface of claim 12, wherein:
a flag is provided for the at least one parent node indicating that it meets the conditions of the filter command when at least one of the plurality of child nodes meets the conditions of the filter command.

14. A computer program product for generating a user interface for displaying information, comprising:
computer code devices configured to cause a computer to generate a display including:
a first display region having a tree with hierarchically-arranged nodes including at least one parent node and a plurality of child nodes thereof; and
a second display region having a table for displaying information associated with the child nodes;
wherein, in accordance with a filter command, the table is updated to display information associated with a subset of the child nodes which meets conditions of the filter command while omitting information associated with remaining ones of the child nodes which do not meet the conditions of the filter command, and the tree is updated to display the subset of child nodes and the at least one parent node while omitting the remaining ones of the child nodes.

15. A computer-generated user interface for displaying information, comprising:
a first display region having a tree with hierarchically-arranged nodes including at least one parent node and a plurality of child nodes thereof; and
a second display region having a table for displaying information associated with the child nodes; wherein:
in accordance with a filter command, the table is updated to display information associated with a subset of the child nodes which meets conditions of the filter command while omitting information associated with remaining ones of the child nodes which do not meet the conditions of the filter command, and the tree is updated to display the subset of child nodes and the at least one parent node while omitting the remaining ones of the child nodes;
a flag is provided for each of the plurality of child nodes indicating whether or not they meet the conditions of the filter command;
a flag is provided for the at least one parent node indicating that the at least one parent node meets the conditions of the filter command when at least one of the plurality of child nodes meets the conditions of the filter command; and
the tree is updated by identifying the subset of the child nodes which meets the conditions of the filter command according to the flag of each of the plurality of child nodes, and by identifying the at least one parent node according to its flag.

16. A computer program product for generating a user interface for displaying information, comprising:
computer code devices configured to cause a computer to generate a display including:
a first display region having a tree with hierarchically-arranged nodes including at least one parent node and a plurality of child nodes thereof; and
a second display region having a table for displaying information associated with the child nodes; wherein:
in accordance with a filter command, the table is updated to display information associated with a subset of the child nodes which meets conditions of the filter command while omitting information associated with remaining ones of the child nodes which do not meet the conditions of the filter command, and the tree is updated to display the subset of child nodes and the at least one parent node while omitting the remaining ones of the child nodes;
a flag is provided for each of the plurality of child nodes indicating whether or not they meet the conditions of the filter command;
a flag is provided for the at least one parent node indicating that the at least one parent node meets the conditions of the filter command when at least one of the plurality of child nodes meets the conditions of the filter command; and
the tree is updated by identifying the subset of the child nodes which meets the conditions of the filter command according to the flag of each of the plurality of child nodes, and by identifying the at least one parent node according to its flag.

17. A computer-generated user interface for displaying information, comprising:
a first display region having a tree with hierarchically-arranged nodes representing storage resources in a computer system, including at least one parent node and a plurality of child nodes thereof; and
a second display region having a table for displaying information associated with the child nodes, including information regarding multiple copy relationships associated with at least one of the child nodes which is grouped in corresponding multiple rows of the table;
wherein, in accordance with a sort command applied to the table, the multiple rows for the multiple copy relationships are sorted while remaining grouped in the table.

18. The computer-generated user interface of claim 17, wherein:
the table displays information regarding multiple copy relationships associated with at least two of the child nodes which is grouped in corresponding multiple rows of the table for each of the at least two child nodes;
wherein, in accordance with the sort command applied to the table, for each of the at least two of the child nodes, the multiple rows for the multiple copy relationships thereof are sorted while remaining grouped in the table.

19. The computer-generated user interface of claim 17, wherein:
the at least one parent node represents a logical storage resource, and the plurality of child nodes represent volumes thereof.

20. The computer-generated user interface of claim 17, wherein:
the sort command sorts on at least one of: storage resource identifier and storage resource size.

21. The computer-generated user interface of claim 17, wherein:
the sort command sorts on characteristics of the copy relationships, including at least one of: an identifier of another storage resource involved in the at least one copy relationship, a source or target status thereof, copy type, copy status and copy progress.

22. The computer-generated user interface of claim 17, wherein:
the first display region is displayed concurrently with the second display region.

23. A computer program product for generating a user interface for displaying information, comprising:
computer code devices configured to cause a computer to generate a display including:
a first display region having a tree with hierarchically-arranged nodes representing storage resources in a computer system, including at least one parent node and a plurality of child nodes thereof; and
a second display region having a table for displaying information associated with the child nodes, including information regarding multiple copy relationships associated with at least one of the child nodes which is grouped in corresponding multiple rows of the table;
wherein, in accordance with a sort command applied to the table, the multiple rows for the multiple copy relationships are sorted while remaining grouped in the table.

24. A computer-generated user interface for displaying information, comprising:
a first display region having a tree with hierarchically-arranged nodes including at least one parent node and a plurality of child nodes thereof, wherein the child nodes are in a first node order; and
a second display region having a table with rows in a first row order for displaying information associated with the child nodes;
wherein, in accordance with a sort command applied to the table, the table is updated so that the rows are in a second row order, and
the tree is updated so that the child nodes are in a second node order in accordance with the second row order.

25. The computer-generated user interface of claim 24, wherein:
the parent node and the plurality of child nodes represent storage resources in a computer system.

26. The computer-generated user interface of claim 24, wherein:
the plurality of child nodes represent storage resources in a computer system;
multiple grouped rows of the table provide information regarding corresponding multiple copy relationship associated with at least one of the storage resources; and
the multiple rows for the multiple copy relationships remain grouped when the table is updated.

27. The computer-generated user interface of claim 26, wherein:
the sort command sorts on at least one of: storage resource identifier and storage resource size.

28. The computer-generated user interface of claim 26, wherein:
the sort command sorts on characteristics of the copy relationships, including at least one of: an identifier of another storage resource involved in the at least one copy relationship, a source or target status thereof, copy type, copy status and copy progress.

29. A computer program product for generating a user interface for displaying information, comprising:
computer code devices configured to cause a computer to generate a display including:
a first display region having a tree with hierarchically-arranged nodes including at least one parent node and a plurality of child nodes thereof, wherein the child nodes are in a first node order; and
a second display region having a table with rows in a first row order for displaying information associated with the child nodes;
wherein, in accordance with a sort command applied to the table, the table is updated so that the rows are in a second row order, and
the tree is updated so that the child nodes are in a second node order in accordance with the second row order.
